(19) United States
(12) Patent Application Publication
(10) Pub. No.: US 2013/0226785 A1
(43) Pub. Date: Aug. 29, 2013

(54) TAX REFUND LOAN SYSTEM ABSENT IRS AND FMS DEBT INDICATOR

(71) Applicants: Stephen S. Krake, Bryson City, NC (US); Chad R. Smith, Bryson City, NC (US)

(72) Inventors: Stephen S. Krake, Bryson City, NC (US); Chad R. Smith, Bryson City, NC (US)

(73) Assignee: Tax Refund Group, Inc., Bryson City, NC (US)

(21) Appl. No.: 13/780,945

(22) Filed: Feb. 28, 2013

Related U.S. Application Data
(60) Provisional application No. 61/604,274, filed on Feb. 28, 2012.

(51) Int. Cl. G06Q 40/02

(52) U.S. Cl. CPC G06Q 40/025
USPC 705/38

(57) ABSTRACT

An aspect of the present invention is a tax refund loan or purchasing system for use in making loan or purchase decisions. The system is an integrated computer system capable of receiving, sending, processing, storing, manipulating financial information as part of an overall loan or purchase decision-making system. The system incorporates certain Internal Revenue Service debt information with certain non-Internal Revenue Service debt information in making loan or purchase decisions.

### CROSS-REFERENCE TO RELATED APPLICATIONS

This patent application claims priority to US Provisional Patent Application with Application Number 61604274, Title “TAX REFUND LOAN SYSTEM ABSENT IRS AND FMS DEBT INDICATOR”, filed on Feb. 28, 2012, commonly assigned herewith, and hereby incorporated by reference.

### BACKGROUND OF THE INVENTION

The present invention is in the technical field of personal lending and finance.

More particularly, the present invention is in the technical field of federal tax refund anticipation lending and purchasing at a discount a federal tax refund.

Due to United States Department of the Treasury policy changes, the Internal Revenue Service stopped sending refund anticipation loan lenders a debt indicator. The debt indicator informed the lender whether there was an IRS debt or a debt reported to the Financial Management Service, a bureau of the US Treasury. If a debt existed, that debt was taken out of the taxpayer's 10 federal refund. The FDIC pressured the lenders to stop lending refund anticipation loans based on the risky nature of the loan absent the debt indicator.

### SUMMARY OF THE INVENTION

The present invention is a tax refund loan or purchasing system which eliminates the risk described above by providing information the automatic debt indicator provided, thus facilitating a tax refund loan or purchasing vehicle for the taxpayer. The present invention is a system by which a financial institution lends money or purchases at discount and disburses money to a taxpayer based on specific research that provides information the IRS debt indicator previously provided.

### BRIEF DESCRIPTION OF THE DRAWINGS

FIG. 1 is a flowchart showing an overview of the tax refund loan or purchasing system from a taxpayer having their return prepared through to the research organization receiving the acceptance status from the IRS, beginning the loan or purchase evaluation/underwriting process.

FIG. 2 is a flowchart of the loan or purchase evaluation and underwriting software program and the overall loan or purchase application process.

### DETAILED DESCRIPTION OF THE INVENTION

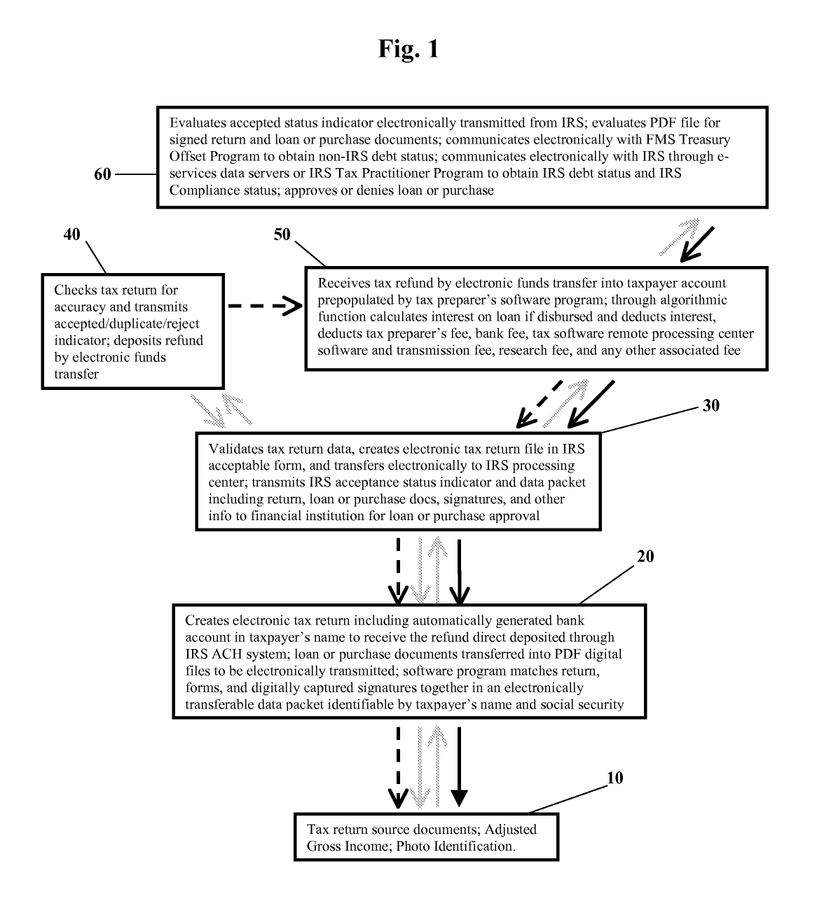

Referring now to FIG. 1 there is a flowchart diagramming the flow of information in electronic form via the internet and the overall data processing functions for the implementation of one embodiment of the invention. Taxpayer 10 enters tax preparer's 20 office to have their tax year ending return prepared from their tax source documents (W2s, 1099s, Social Security Cards, etc.). Taxpayer 10 also applies for a personal loan or purchase from financial institution 50 which requires taxpayer's 10 social security number, name, date of birth, address, taxpayer's 10 personal identification number, phone number, federal tax refund amount, refund amount after all non-loan or non-purchase fees (tax preparation fee, bank fee, software fee, transmission fee, and any document preparation fees), one of the previous three years adjusted gross income from taxpayer's 10 tax returns, and the current date.

Input means using a computer with data processing, data storage, image processing, and internet transmission capabilities; keyboard; mouse; visual display; printer; and tax return preparation program software provided by tax software remote processing center 30 are used by tax preparer 20 for inputting taxpayer's 10 tax source document information and information required for personal loan or purchase. Once data input is complete, the tax return preparation program software is executed by data processing means to create an electronic tax return including an automatically generated bank account number in the taxpayer's 10 name and held with financial institution 50 to receive the refund by way of electronic funds transfer using the Treasury ACH origination system. The financial institution's 50 routing number and automatically generated bank account number are populated on the taxpayer's 10 electronic return notifying the IRS processing center 40 of the taxpayer's 10 choice to have their return direct deposited. The tax return preparation program software also validates the tax return data for errors that may cause the tax return to be rejected by the IRS processing center 40.

Also, once data input is complete, the tax return preparation program software is executed by data processing means to generate IRS Form 2848 or 8821 and Financial Management System Form 13 authorizing the research organization 60 to receive information and communicate with the individual departments of the United States Treasury; a consent statement authorizing tax preparer 20, tax software remote processing center 30, financial institution 50, and research organization 60 to use and share taxpayer's 10 information; a loan or purchase application requesting the applicable loan or purchase amount taking into account the interest charged if applicable, tax preparation fees, research fees, bank fees, software fees, transmission fees, and any document preparation fees; promissory note for the loan amount requested if applicable; limited power of attorney allowing the financial institution 50 to receive the tax refund and deduct the interest charged if applicable, tax preparation fees, research fees, bank fees, software fees, transmission fees, any document preparation fees, and loan or purchase amount disbursed; disclosure required by federal and state lending law showing the loan amount if applicable, interest charged if applicable, tax preparation fees, research fees, bank fees, software fees, transmission fees, and any document preparation fees.

The taxpayer 10 signs tax return and loan or purchase documents on an electronic signature pad which digitally captures taxpayer's 10 signature. The tax return preparation program software is executed and matches tax return, loan or purchase documents, and digital signatures together in a data packet categorized with taxpayer's name and social security number and transmits through internet connection to the tax software remote processing center 30. The tax return preparation program software also creates a PDF image of the tax return and document and digitally stores the document for printing. One printed copy of all documents is then given to taxpayer 10.

After the tax software remote processing center 30 receives the data packet, a program process is executed which validates the tax return. If the taxpayer's 10 data fails this layer of validation the tax return is then sent back to the tax preparer 20 to correct. If the validation is successful the program creates the electronic in the format required by the IRS and transfers the file electronically to the IRS processing center 40.

Once the IRS processing center 40 receives the file, a program executes a series of checks to verify the accuracy of the taxpayer's 10 return including matching names, social security numbers, and birthdays with the information reported to the Social Security Administration; verifying a previous tax return with the same taxpayer's 10 social security number has not already been accepted; verifying that any dependents claimed on the taxpayer's 10 return has not already been reported on another return and accepted; and a battery of other checks for accuracy and verification. The IRS processing center 40 then electronically transmits a status indicator code of accepted, duplicate, or rejected, including the reason for the rejection back to the tax software remote processing center 30.

If the status indicator acknowledges the taxpayer's 10 return has been accepted, the tax software remote processing center 30 electronically forwards the taxpayer's 10 data packet with the IRS accepted status indicator to the financial institution 50 who then electronically forwards the data packet to the research organization 60 for loan or purchase acceptance or rejection evaluation. If the IRS status indicator is duplicate, the tax software remote processing center 30 electronically forwards the duplicate status indicator to the tax preparer 20. At that point the tax preparer 20 can decide how to handle the situation and no further tax return electronic processing or loan or purchase acceptance evaluation occurs. If the IRS status indicator is a rejection, the tax software remote processing center 30 electronically forwards the rejected status indicator with the reason for the rejection received by the IRS processing center 40 to the tax preparer 20 for correction and re-transmittal through to the IRS processing center 40 for an accepted status indicator which can then be forwarded through to the financial institution 50 and the research organization 60 for evaluation of loan or purchase acceptance.

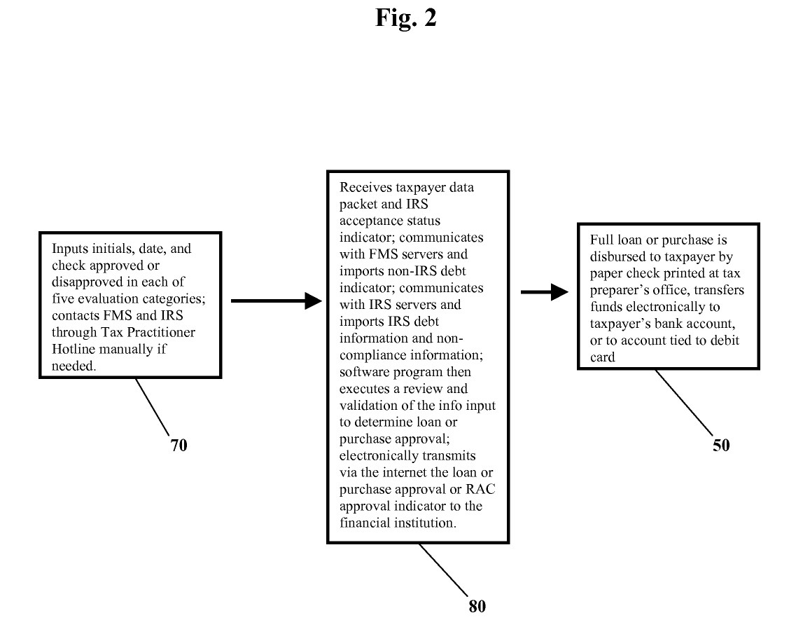

Now referring in more detail to FIG. 2, after the research organization 60 electronically receives the taxpayer's 10 data packet and IRS accepted status indicator from the financial institution 50, the loan or purchase acceptance evaluation program 80 is executed. Input means using a computer with data processing, data storage, image processing, and internet transmission capabilities; keyboard; mouse; visual display; printer; and loan or purchase evaluation software program 80 are used by a research analyst 70 for imputing taxpayer's 10 five evaluation keys. The software program is categorized by taxpayer's 10 name and social security number and each taxpayer 10 has their own data file. The IRS accepted status indicator is already populated in the taxpayer's 10 individual data file when received electronically along with the taxpayer's 10 social security number, name, date of birth, address, taxpayer's 10 personal identification number, phone number, federal tax refund amount, refund amount after all non-loan or purchase fees (tax preparation fee, bank fee, software fee, transmission fee, and any document preparation fees), one of previous three years adjusted gross income, the current date; and the taxpayer's 10 PDF file containing the signed tax return and loan or purchase documents.

The research analyst 70 then inputs their initials with date and time next to each of the five categories in the taxpayer's 10 data file and checks one box of either approved or disapproved. The five categories for evaluation are the required presence of the IRS acceptance status indicator. Second, it is required that the tax return and all required loan or purchase documents are signed. Third, it is required that there is no non-IRS debt, which will offset the taxpayer's 10 refund. Fourth, it is required that if there is an IRS debt there will be enough refund left to pay the interest charged if applicable, tax preparation fees, research fees, bank fees, software fees, transmission fees, any document preparation fees, and the loan or purchase amount disbursed. Fifth, it is required that the taxpayer 10 is compliant with the IRS. To be compliant the taxpayer 10 must have filed every year they are required to according to the IRS standards, must not have any outstanding notices from the IRS, the taxpayer 10 cannot have any previous years income or account being reviewed or examined, there cannot be a history where the taxpayer's 10 refund is taken to cover IRS or non-IRS debt, or any other situation where the taxpayer's 10 refund will not cover the interest charged if applicable, tax preparation fees, research fees, bank fees, software fees, transmission fees, any document preparation fees, and the loan or purchase amount disbursed.

Depending on the non-compliance it is up to the research organization 60, the financial institution 50, the tax software remote processing center 30, the tax preparer 20, and the taxpayer 10 whether or not it is financially feasible to help the taxpayer 10 reach compliant status.

Returning now to the evaluation of the third requirement, the research analyst 70 uses either the data processing/transmitting/and receiving system to electronically communicate with the US Department of Treasury's Financial Management System (FMS) Treasury Offset Program or calls the FMS Treasury Offset Program Hotline automated electronic telephone system to determine whether there is a non-IRS debt. If there is a non-IRS debt that will offset the taxpayer's 10 refund then no further evaluation needs to take place, the loan or purchase application is not approved, the application automatically converts into what is commonly referred to in the industry as a RAC or refund anticipation check and electronically transmits the refund anticipation check acceptance indicator to the financial institution 50 who then forwards the indicator to the tax software remote processing center 30 who then forwards the indicator to the tax preparer 20 and on to the taxpayer 10. A refund anticipation check is a vehicle whereby the IRS electronically transmits taxpayer's 10 refund into the bank account held with the financial institution 50 and generated and reported on the tax return by the tax return preparation software. The financial institution 50 then deducts the tax preparation fees, research fees, bank fees, software fees, transmission fees, any document preparation fees and disburses the remaining portion of the tax refund to the taxpayer 10. The disbursement methods for making any remaining portion of the tax refund available to the taxpayer 10 are described in more detail later. The financial institution 50 then electronically transmits the funds to the corresponding accounts.

Returning now to the evaluation of the fourth and fifth requirements, the research analyst 70 uses either the data processing, transmitting, and receiving system to electronically communicate over the internet with the IRS electronic transcript data servers and IRS e-services or calls the IRS Tax Practitioner's Hotline to determine if there in an IRS debt and if there is, whether or not there will be enough of a refund available to pay the interest charged if applicable, tax preparation fees, research fees, bank fees, software fees, transmission fees, any document preparation fees, and the loan or purchase amount disbursed. The research analyst 70 signs into the IRS electronic system using the research organization's 60 username and password, and inputs the taxpayer's 10 information for one of the previous three years into the online 2848 or 8821. The IRS e-services online program then executes and verifies the data. Once verified the research analyst 70 can then submit the online 2848 or 8821. Now the research analyst 70 can access the taxpayer's 10 transcripts through the IRS online transcript delivery system. The research analyst 70 inputs the data to pull the account transcripts for the previous three years and any and all other transcripts such as return transcripts or wage and income transcripts if there is IRS non-compliance that can be corrected. The research analyst 70 then prints each transcript into a PDF file, names the file the corresponding year and taxpayer's 10 social security number, and imports the PDF file into category four of the taxpayer's 10 data file of the loan or purchase acceptance evaluation program 80. Next, the loan or purchase acceptance evaluation program 80 or the research analyst 70 reviews the data in the transcripts to determine if there is a current IRS debt, an IRS non-compliance situation as set out in detail previously, and if there is an IRS debt whether there will be enough refund remaining to cover the interest charged if applicable, tax preparation fees, research fees, bank fees, software fees, transmission fees, any document preparation fees, and the loan or purchase amount disbursed.

Referring back now to FIG. 1, if all five categories pass evaluation, then the research organization 60 electronically transmits the loan or purchase approval indicator to the financial institution 50 with the approved loan or purchase amount to be disbursed. The full loan or purchase amount is then disbursed, in the way chosen by the taxpayer 10 at the time of filing with the tax preparer 20, by the financial institution 50 with a paper check in which a check print authorization indicator is sent to the tax software remote processing center 30 and on to the tax preparer 20 where the check is printed for the taxpayer 10 to pick up; using electronic funds transferred into the taxpayer's 10 already existing bank account which was input at the time of filing with the tax preparer 20; or using electronic funds transferred into a debit card account held with the financial institution 50, given to the taxpayer 10 at the time of filing with the tax preparer 20, which is tied to the account which was automatically generated by the tax preparation software program set out in detail previously.

Upon processing the taxpayer's 10 tax return and passing the requisite battery of tests, the IRS processing center 40 transmits the refund, by electronic funds transfer, to the taxpayer's 10 account which was automatically generated by the tax preparation software program set out in detail previously and held with the financial institution 50. Using the algorithmic function created for the financial institution 50 the interest on the loan if applicable, tax preparation fees, research fees, bank fees, software fees, transmission fees, any document preparation fees, and the loan or purchase amount disbursed is calculated, taken out of the refund, and disbursed by electronic funds transfer to the appropriate accounts held by the financial institution 50, the tax preparer 20, the research organization 60, and the tax preparation software remote processing center 30.

The remaining amount of the taxpayer's 10 refund, if any, is then disbursed through the methods described in detail above by a paper check, electronic funds transferred and direct deposited into the taxpayer's 10 existing bank account, or electronic funds transferred and direct deposited into the debit card account held with the financial institution 50 which is tied to the account automatically generated by the tax preparation software program.

This refund loan or purchase system which replaces the IRS debt indicator eliminates the risk which concerned the FDIC and now allows the financial institution 50 to resume refund anticipation lending or purchasing. It can result in lower transaction costs assessed to the taxpayer 10 by cutting out the middle man present now who manually deducts fees from the refund and replaces him directly with the bank who electronically and automatically processes the refund and fees. It also gives the choice back to taxpayer 10 who once again will have the freedom to determine their own financial need and in their own time. This refund system can make a portion of the taxpayer's 10 refund available in as quick as the same day they file as opposed to the seven to twenty-eight days proposed by the IRS. This year with the IRS software problems, including switching from the legacy program to the modern e-filing program, delays have been felt nationwide and refunds times, including direct deposits, have been varied from as little as nine days to as long twenty-two days. This refund system also helps in determining the IRS compliance status of taxpayers 10 and giving them notice to correct the compliance issues in order to receive a refund loan.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will prove the same result and fall within the spirit of the claimed invention.

What is claimed is:

1. A financial evaluation process, comprising:
receiving taxpayer Internal Revenue Service debt data;
receiving a Financial Management Service non-Internal Revenue Service debt data;
receiving a loan or purchase request;
comparing the tax payer Internal Revenue Service debt data and the Financial Management Services non-Internal Revenue Service debt indicator against the loan or purchase request; and,
accepting or rejecting the loan or purchase request based upon the compared Internal Revenue Service debt data and the Financial Management Services non-Internal Revenue Service debt indicator with respect to the loan or purchase request.

2. A system comprising:
at least one computer processor; and
at least some memory bearing one or more instructions that, when executed by the at least one computer processor, facilitate operations including:
obtaining status information associated with one or more taxpayer Internal Revenue Service debt data;
obtaining input information at least partly from at least one Financial Management Service non-Internal Revenue Service debt data provider; and,
determining loan or purchase assessment information with respect to the at least one specified borrower or purchaser at least partly on the status information and the input information.
